(19) United States
(12) Patent Application Publication
(10) Pub. No.: US 2001/0025792 A1
(43) Pub. Date: Oct. 4, 2001

(54) Pseudoradial electrophoresis chip

(76) Inventor: Shaorong Liu, Tracey, CA (US)

Correspondence Address: AMERSHAM PHARMACIA BIOTECH INC., PATENT DEPARTMENT, P O BOX 1327, 800 CENTENNIAL AVENUE, PISCATAWAY, NJ, 088551327

(21) Appl. No.: 09/808,375

(22) Filed: Mar. 14, 2001

Related U.S. Application Data
(60) Provisional application No. 60/189,148, filed on Mar. 14, 2000.

(51) Int. Cl. G01N 27/26; G01N 27/447

(52) U.S. Cl. 204/451; 204/601

(57) ABSTRACT

A microfabricated capillary array electrophoresis chip includes a planar substrate having a first major surface defining converging first and second elongate separation channels. Each separation channel extends between an associated cathode port and anode port defined by the first major surface. The substrate further comprises a first perimetrical edge segment extending substantially along the first separation channel, and a second perimetrical edge segment extending substantially along the second separation channel. The perimetrical edge segments of a pair of chips of the present invention are cooperatively engageable so as to provide an electrophoresis separation plate having psuedoradially-aligned separation channels.

### FIELD OF THE INVENTION

The present invention relates generally to the field of electrophoresis chips. More particularly, the present invention relates to an electrophoresis chip having a pseudoradial design.

### BACKGROUND OF THE INVENTION

Increasingly, DNA sequencing separations demand cost-effective high-throughput, high-performance sequencing technologies. DNA sequencing separations using slab gel technology has been supplanted by capillary array electrophoresis (CAE). The throughput of a CAE system is directly proportional to the number of separation capillaries in the instrument. However, as the number of capillaries increases, it becomes more challenging to control sample injection and to detect signals from all of the capillaries.

Another technology for high-throughput DNA analysis is capillary array electrophoresis on microchips. Microchips are planar members typically formed from a glass, silica, or even polymeric material. Photolithographic techniques are typically used to microfabricate CAE channels on substrates. The microchip substrate defines at least one elongate capillary channel which extends between opposed cathode and anode ports. Sample and waste ports are located adjacent the cathode port and channel segments extend therefrom to the elongate microchannel. As is well-known in the art, when a biological fluid sample is deposited in the sample port, electrical potential may be applied to the four ports so as to direct a portion of the fluid sample first into the elongate microchannel and then towards the opposed anode port. The fluid sample, which separates into different-length segments of gene fragments, is analyzed as it passes a point in the channel at which is read by an interrogation device. Microchips have been used, for example, to separate fluorescent dyes, fluorescently-labeled amino acids, DNA restriction fragments, PCR products, short oligonucleotides, short tandem repeats, and DNA sequencing fragments.

In order to increase throughput, multiple CAE channels have been microfabricated on microchips and used for DNA fragment size analysis. Channels on many substrate designs include right angle turns that work well for fragment sizing but which degrade performance in sequencing separations. Alternate designs, using a round substrate, include radially-extending channels terminating at a common, centrally-located anode. For example, Shi et al. in Anal. Chem. 1999, 71, 5354-5361, disclose a 96 channel radial CAE microchip design for use with a rotary confocal fluorescence detection system. The 96 channels are formed on a 10 centimeter diameter Borofloat substrate so as to extend from a common, centrally-located anode. Such a design makes effective use of the chip space in providing uniform-length channels while still allowing a detector to scan perpendicularly across all of the channels. One drawback to this design, however, is that the effective channel lengths are limited to less than one-half of the chip diameter, or here to 3.3 centimeters for a 10 centimeter diameter chip. The effective channel length refers to the distance a fluid would travel through a channel before reaching the point where it is interrogated by an analytical device. While channels of this length work well for separations of certain restriction fragments and genotyping samples, it is very challenging to achieve sequencing separations using such short channels. In order to increase the length of the channels, larger-diameter chips may obviously be used, however the fabrication costs of suitable larger chips can be cost-prohibitive.

There is therefore a need in the art for a cost-effective high-throughput, high-performance electrophoresis microchip which maximizes formation of uniform-length, elongate electrophoresis separation microchannels thereon. There is also a need in the art for an electrophoresis microchip which provides a compact array of microchannels so as to increase throughput.

### SUMMARY OF THE INVENTION

The present invention addresses the needs of the art by providing a shaped microfabricated capillary array electrophoresis chip including a planar substrate having a first major surface defining converging first and second elongate separation channels. Each separation channel extends between an associated cathode port and anode port defined by the first major surface. The substrate further comprises a first perimetrical edge segment extending substantially along the first separation channel, and a second perimetrical edge segment extending substantially along the second separation channel. The perimetrical edge segments of a pair of shaped chips of the present invention are cooperatively engageable so as to provide an electrophoresis separation plate having psuedoradially-aligned separation channels.

The present invention also discloses a method of forming the shaped capillary array electrophoresis chip by the steps of providing a substantially planar substrate having a first major surface, forming first and second converging elongate separation channels in the first major surface, forming a first perimetrical edge segment extending along the first separation channel; and forming a second perimetrical edge segment extending along the second separation channel. The perimetrical edge segments of a pair of such shaped chips cooperatively align so as to provide a capillary array electrophoresis platform of pseudoradially-aligned separation channels. The perimetrical edge segments of each shaped chip making up a platform may be formed at specific angles to each other so as to allow a set number of shaped chips to approximate a semi-circlular or a circular array of separation channels.

The present invention thereby eliminates the need to form a single large substrate for containing all of the separation channels to be employed. By forming groups of separation channels on distinct cooperatively-shaped chips, a large array of uniform length separation channels suitable for electrophoretic separation may be provided in a cost effective manner. The number of separation channels provided is greatly increased due to the increase in combined surface area of multiple shaped chips of the present invention. Additionally, should a channel in one of the shaped chips not function properly, only the particular chip on which the malfunctioning channel is located need be replaced.

### BRIEF DESCRIPTION OF THE DRAWINGS

FIG. 1 depicts the arrangement of microchannels on a first substrate in accordance with the present invention.

FIG. 2 depicts the arrangement of the cathode, sample, and waste ports for a pair of microchannels of the present invention.

FIG. 3 depicts a shaped chip of the present invention, formed from the substrate of FIG. 1.

FIG. 4 depicts a pseudoradial separation channel platform of the present invention.

FIGS. 5a-b depict alternate arrangements of the cathode, sample, and waste reservoirs for a pair of microchannels of the present invention.

### DETAILED DESCRIPTION OF THE PREFERRED EMBODIMENT

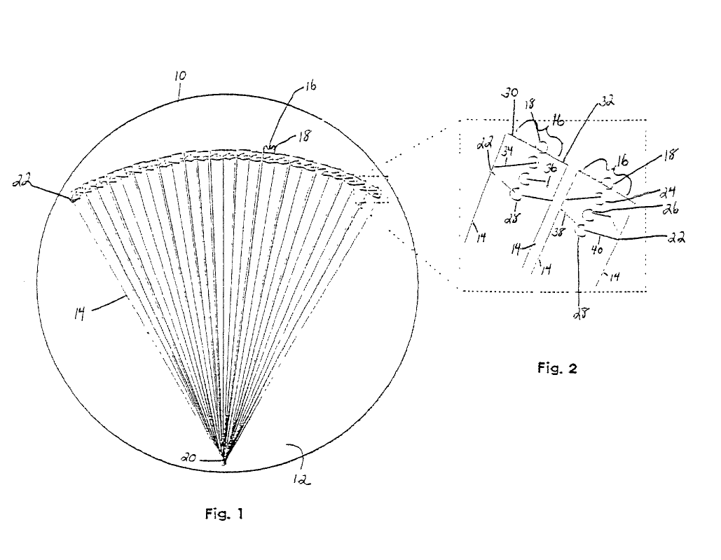

FIG. 1 depicts a round substrate 10 on which an array of radially-aligned micro separation channels 14 of the present invention is formed. Substrate 10 is desirably formed of a material suitable for electrophoresis microchips including, by way of illustration and not of limitation, glass, silica, or a polymeric material. Substrate 10 may be formed using photolithographic techniques as is known in the art. While shown to be circular in shape, the present invention further contemplates that substrate 10 may be formed in any shape suitable for an electrophoresis separation device.

The present invention contemplates forming substrate 10 having a planar first major surface 12 which defines grouped pairs 16 of elongate separation channels 14. Each grouped pair 16 of separation channels 14 extend in fluid communication from a common cathode port 18. Desirably, each separation channel 14 also extends in fluid communication from a common anode port 20. Each separation channel 14 further includes a loading segment 22 from which each microchannel linearly extends in fluid communication with anode port 20. Microchannels 14 are thereby formed in a converging relationship between each loading segment 22 and common anode port 20. Conversely stated, microchannels 14 radially extend from common anode port 20 towards their respective loading segments 22.

With additional reference to FIG. 2, first major surface 12 also defines an associated first and second group sample ports 24 and 26 for each separation channel 14 of the respective grouped pair 16 of separation channels. Furthermore, first major surface 12 defines a common group waste port 28 for each grouped pair 16 of separation channels. First major surface 12 additionally defines cathode channel segments 30 and 32 extending in fluid communication between cathode port 18 and each of the separation channels 14 of each grouped pair 16. Similarly, first major surface 12 defines sample channel segments 34 and 36 extending from sample ports 24 and 26, respectively, to their respective separation channel 14. First major surface 12 also defines waste channel segments 38 and 40 extending from each channel 14 of a grouped pair 16 to common group waste port 28. Each associated group sample port 24 and 26 is therefore in fluid communication with its group waste port 28 across the respective loading segment 22 of a single separation channel 14.

Cathode ports 18, sample ports 24 and 26, and waste ports 28 are desirably formed having a diameter in the range of about 500 microns to about 1.2 millimeters. Anode port 20 is desirably formed having a diameter of about 1 to about 2 millimeters. Each separation channel 14, including the associated channel segments 30, 32, 34, 36, 38, and 40, are desirably formed having a width of about 10 microns to about 500 microns, preferably about 110 microns.

The actual dimensions of the ports, channels, and channel segments defined by first major surface 12, as understood in the art, will be selected according to the number of channels desired to be formed on a given substrate. For example, starting with a substrate 10 having a diameter of about 15 centimeters, the present invention contemplates forming 64 elongate separation channels 14 having a uniform length between about 7 and about 12 centimeters. Similarly, a substrate 10 having a diameter of about 15 centimeters may accommodate 48 elongate separation channels 14 having a uniform length between about 8 and about 13 centimeters.

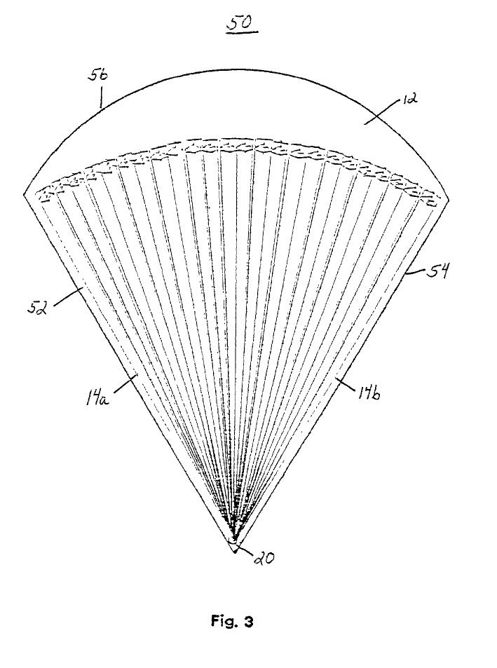

Referring now to FIG. 3, a shaped microfabricated capillary array electrophoresis chip 50 of the present invention is formed by dicing, or trimming, substrate 10. A first perimetrical edge segment 52 is formed substantially along a first outermost separation channel 14a and a second perimetrical edge segment 54 is formed substantially along a second opposed outermost channel 14b. Shaped chip 50 may retain circular perimetrical edge 56 from the original substrate 12. Perimetrical edge segments 52 and 54 desirably are formed at an angle to each other that is some even fraction of either 180 degrees or 360 degrees. However, the present invention also contemplates that each shaped chip 50 may be formed having different angles formed between their respective perimetrical edge segments 52 and 54. The present invention further contemplates that each shaped chip 50 may be formed starting with a substrate already having the fan-shape of the diced substrate 10. Shaped chip 50 is shown having perimetrical edge segments 52 and 54 formed at a 60 degree angle relative to each other.

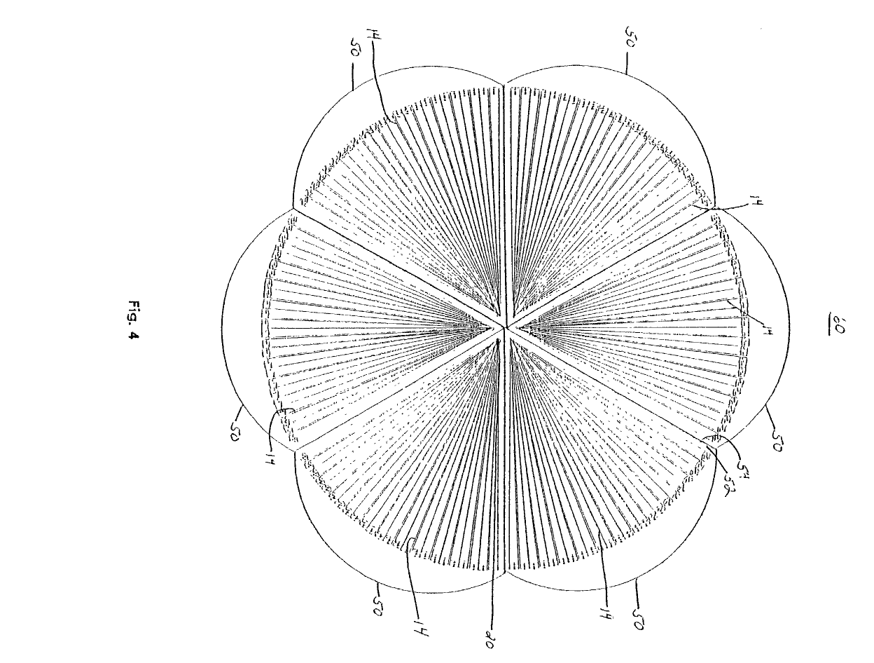

As shown in FIG. 4, a microfabricated capillary array electrophoresis platform 60 is formed by six shaped chips 50 aligned such that their perimetrical edges cooperatively engage each other. Electrophoresis platform 60 provides 288 pseudoradially-aligned separation channels 14. The number of separation channels 14 provided by an electrophoresis platform 60 of the present invention will be a function of the number of separation channels 14 included on each shaped chip 50. The present invention further contemplates that six shaped chips 50 each including 64 elongate separation channels 14 thereon may be similarly combined to provide a pseudoradially-aligned array of 384 separation channels 14. As each shaped chip 50 includes its own anode port 20, it is not necessary that all of the separation channels 14 be radially aligned in order to take maximum advantage of the additional surface area provided by a plurality of shaped chips 50.

As is known in the art, a biological fluid sample may be delivered into each sample port 24 and 26 of each grouped pair 16 of separation channels 14. Electrical probes may then be inserted to each of the cathode ports, sample ports, waste ports and the anode port. By varying the electrical potential among the probes, the fluid sample may be forced to migrate from the sample ports to the respective loading segments 22. The electrical potential delivered by each probe may then be selected to cause the electrophoretic separation and migration of the fluid sample towards anode port 20.

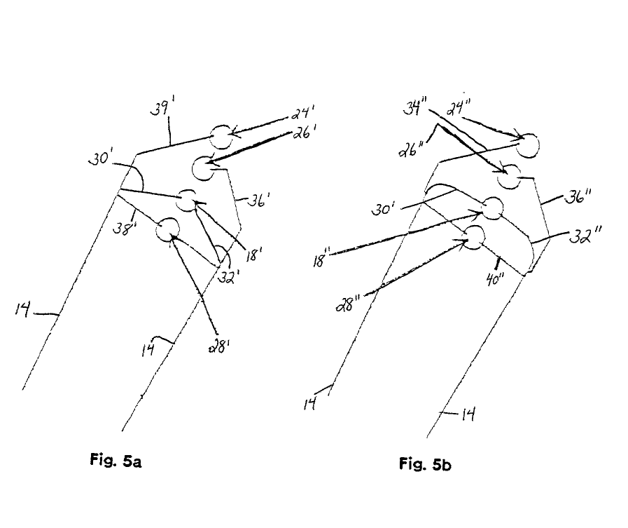

FIGS. 5a-b depict alternate embodiments for the arrangement of the cathode ports, sample ports, and waste ports for each grouped pair 16 of separation channels 14. FIG. 5a depicts cathode port 18′ and waste port 28′ connected in parallel, in fluid communication, between a grouped pair 16 of separation channels 14 via segments 30′, 32′and 38′, 40′, respectively. Sample ports 24′ and 26′ are each in fluid communication with one separation channel 14 of each grouped pair 16 via a single channel segment 34′ and 36′, respectively. Channel segment 36′ is shown having a right-angle turn formed therein while the remaining channel segments are shown to extend linearly. FIG. 5b depicts cathode port 18″ and waste port 28″ connected in parallel, in fluid communication, between a grouped pair 16 of separation channels 14 via segments 30″, 32″ and 38″,40″, respectively. Sample ports 24″ and 26″ are each in fluid communication with one separation channel 14 of each grouped pair 16 via a single channel segment 34″ and 36″, respectively. Channel segment 36″ is shown having a right-angle turn formed therein while the remaining channel segments 30″ and 32″ are shown to extend curvilinearly. The remaining channel segments extend linearly.

While the particular embodiment of the present invention has been shown and described, it will be obvious to those skilled in the art that changes and modifications may be made without departing from the teachings of the invention. The matter set forth in the foregoing description and accompanying drawings is offered by way of illustration only and not as a limitation. The actual scope of the invention is intended to be defined in the following claims when viewed in their proper perspective based on the prior art.

What is claimed is:

1. A shaped microfabricated capillary array electrophoresis chip comprising:
a planar substrate having a first major surface defining converging first and second elongate separation channels, wherein each said separation channel extends between an associated cathode port and an anode port defined by said first major surface, wherein said substrate further comprises a first perimetrical edge segment extending substantially along said first separation channel, and a second perimetrical edge segment extending substantially along said second separation channel.

2. A shaped microfabricated capillary array electrophoresis chip according to claim 1, wherein each said separation channel extends in fluid communication with a common anode port.

3. A shaped microfabricated capillary array electrophoresis chip according to claim 1, wherein said first major surface further defines an associated sample port and waste port for each said separation channel whereby each said associated sample port and waste port is in fluid communication across a loading segment of a single said separation channel.

4. A shaped microfabricated capillary array electrophoresis chip according to claim 1, wherein each said separation channel extends linearly between its respective said loading segment and said anode port.

5. A shaped microfabricated capillary array electrophoresis chip according to claim 1, wherein said first perimetrical edge and said second perimetrical edge are oriented at an angle therebetween being a whole fraction of 180 degrees.

6. A shaped microfabricated capillary array electrophoresis chip according to claim 1, wherein said first perimetrical edge and said second perimetrical edge are oriented at an angle therebetween being a whole fraction of 360 degrees.

7. A shaped microfabricated capillary array electrophoresis chip according to claim 1, wherein each said cathode port is further in fluid communication with a pair of elongate separation channels.

8. A shaped microfabricated capillary array electrophoresis chip according to claim 1, further comprising a plurality of separation channel groups, wherein each said separation channel group includes a grouped pair of elongate separation channels extending in fluid communication between a common cathode port and anode port, wherein each separation channel of said grouped pair of separation channels further includes a loading segment, whereby said first major surface further defines an associated group sample port and a group waste port for each separation channel of said grouped pair of separation channels wherein each associated group sample port and group waste port are in fluid communication across said loading segment of a single separation channel.

9. A shaped microfabricated capillary array electrophoresis chip according to claim 8, wherein each said separation channel group extend in fluid communication from a common anode port.

10. A method for forming a shaped capillary array electrophoresis chip comprising the steps of:
providing a substantially planar substrate having a first major surface;
forming first and second converging elongate separation channels in said first major surface;
forming a first perimetrical edge segment extending along said first separation channel; and
forming a second perimetrical edge segment extending along said second separation channel.

11. The method of claim 10, further comprising the step of:
forming said first and second perimetrical edge segments to be aligned at an angle being an even fraction of 180 degrees.

12. The method of claim 10, further comprising the step of:
forming said first and second perimetrical edge segments to be aligned at an angle being an even fraction of 360 degrees.

13. The method of claim 10, further comprising the step of:
forming a first cathode port in said first major surface and an anode port in said first major surface wherein said first separation channel extends in fluid communication between said first cathode port and said anode port.

14. The method of claim 13, further comprising the step of:
forming a second cathode port in said first major surface wherein said second separation channel extends in fluid communication between said second cathode port and said anode port.

15. The method of claim 10, further comprising the step of:
forming a first associated sample port and waste port in fluid communication across a loading segment of said first sample channel.

16. The method of claim 10, further comprising the step of:
forming said first sample channel to extend linearly between said loading segment and said anode port.

17. The method of claim 10, further comprising the step of:
forming a plurality of separation channel groups in said first major surface, wherein each said separation channel group includes a grouped pair of elongate separation channels extending in fluid communication between a common cathode port and anode port, wherein each separation channel of said grouped pair of separation channels further includes a loading segment, whereby said first major surface further defines an associated group sample port and a group waste port for each separation channel of said grouped pair of separation channels wherein each associated group sample port and group waste port are in fluid communication across said loading segment of a single separation channel.

18. The method of claim 17, wherein said step of forming a plurality of separation channel groups further comprises the step of forming each said grouped pair of separation channels to extend in fluid communication with a common anode port.

19. The method of claim 10, further comprising the step of:
forming 48 converging elongate separation channels in said first major surface.

20. A microfabricated capillary array electrophoresis platform comprising a first chip of claim 1 and a second chip of claim 1, wherein said first perimetrical edge segment of said first chip of claim 1 cooperatively engages one of said first and second perimetrical edge segments of said second chip of claim 1.
